(19) United States
(12) Patent Application Publication
(10) Pub. No.: US 2009/0064023 A1
(43) Pub. Date: Mar. 5, 2009

(54) INFORMATION PROCESSING DEVICE, METHOD AND COMPUTER-READABLE STORAGE MEDIUM

(75) Inventor: Yoji KUDO, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/054,586

(22) Filed: Mar. 25, 2008

(30) Foreign Application Priority Data
Sep. 5, 2007 (JP) 2007-230563

(51) Int. Cl. G06F 3/048

(52) U.S. Cl. 715/771

(57) ABSTRACT

A memory stores information which includes, in correspondence with each other, an input unit to be operated to instruct execution of a function of the information processing device, a first cost required to instruct the execution of the function using the input unit, and an instruction method to instruct the execution, with the first cost and using the input unit. An identification unit identifies which of the plurality of input units is being operated to instruct the execution of the function by a user. A measurement unit measures a second cost required from start of the user's operation of the identified input unit up to instruction of the execution of the function. If the measured second cost differs from the first cost stored in correspondence with the identified input unit, a presentation unit presents to the user information on the instruction method stored in correspondence with the identified input unit.

### CROSS-REFERENCE TO RELATED APPLICATIONS

This application is based on and claims priority under 35 USC 119 from Japanese Patent Application No. 2007-230563 filed Sep. 05, 2007.

### BACKGROUND

1. Technical Field

The present invention relates to an information processing device and method and a computer-readable storage medium

2. Related Art

Heretofore, operation guidance devices have been known in which, when an operator performs a task with some objective, details of an operational procedure (“help”) are displayed.

### SUMMARY

According to an aspect of the invention, a memory stores information which includes, in correspondence with each other, an input unit to be operated to instruct execution of a function of the information processing device, a first cost required to instruct the execution of the function using the input unit, and an instruction method to instruct the execution, with the first cost and using the input unit. An identification unit identifies which of the plurality of input units is being operated to instruct the execution of the function by a user. A measurement unit measures a second cost required from start of the user's operation of the identified input unit up to instruction of the execution of the function. If the measured second cost differs from the first cost stored in the memory in correspondence with the identified input unit, a presentation unit presents to the user information on the instruction method stored in the memory in correspondence with the identified input unit.

### BRIEF DESCRIPTION OF THE DRAWINGS

Exemplary embodiments of the present invention will be described in detail based on the following figures, wherein:

FIG. 1 is a schematic diagram showing an information processing device relating to a present exemplary embodiment.

FIG. 2 is a diagram showing a flowchart of an operation frequency detection processing routine performed by a PC of the present exemplary embodiment.

FIG. 3 is a diagram showing an operation frequency registration table of the present exemplary embodiment.

FIG. 4A and FIG. 4B are diagrams for explaining a method of detecting a number of operations of a mouse in the present exemplary embodiment.

FIG. 5 is a diagram for explaining a method of detecting a number of operations of a keyboard in the present exemplary embodiment.

FIG. 6 is a diagram showing a flowchart of an optimum method presentation processing routine performed by the PC of the present exemplary embodiment.

FIG. 7A and FIG. 7B are diagrams for explaining a method of measuring a cost of a mouse in the present exemplary embodiment.

FIG. 8 is a diagram for explaining a method of measuring a cost of a keyboard in the present exemplary embodiment.

FIG. 9 is a diagram showing a minimum cost registration table of the present exemplary embodiment.

FIG. 10A and FIG. 10B are diagrams showing examples of display at a display device of the present exemplary embodiment.

### DETAILED DESCRIPTION

Herebelow, an exemplary embodiment of the image processing device of the present invention will be described in detail with reference to the drawings.

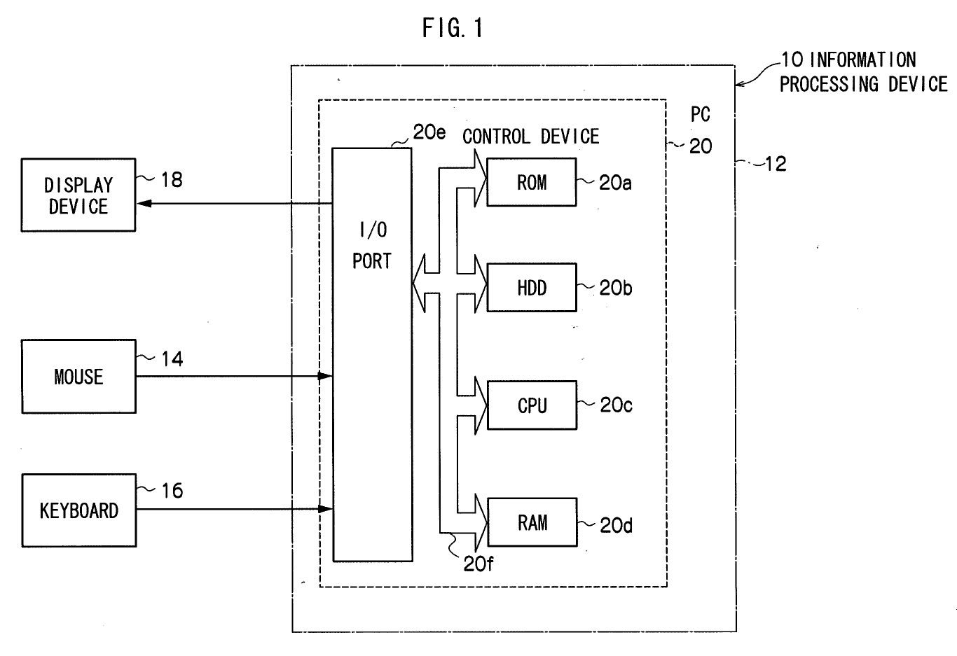

As shown in FIG. 1, an information processing device 10 relating to the present exemplary embodiment is provided with a personal computer (below referred to as a PC) 12, which executes predetermined functions and serves as an image processing device main body, a mouse 14, which is operated by a user to execute the predetermined functions and serves as an input unit, a keyboard 16, which is operated by the user to execute the predetermined functions and serves as an input unit, and a display device 18, which is provided with an LCD that implements displays based on inputted information.

The mouse 14 is provided with a click-button and a ball for moving a cursor displayed at the display device 18, or the like, and outputs corresponding signals when operated.

The keyboard 16 is provided with a plurality of keys, and outputs corresponding signals when operated.

The PC 12 is structured to include a control device 20.

The control device 20 is constituted by a microcomputer which is structured to include a ROM 20a, an HDD (hard disk drive) 20b, a CPU 20c, a RAM 20d and an I/O (input/output) port 20e. The ROM 20a serves as a storage medium at which basic programs such as an OS and the like are memorized. The HDD 20b serves as a storage medium at which a program for executing an operation frequency detection processing routine, a program for executing an optimum method presentation processing routine, and programs for executing various other processing routines are memorized. The CPU 20c reads and executes programs from the ROM 20a and the HDD 20b. The RAM 20d temporarily memorizes various kinds of data. The ROM 20a, HDD 20b, CPU 20c, RAM 20d and I/O port 20e are connected to one another by a bus 20f. The mouse 14, the keyboard 16 and the display device 18 are connected to the I/O port 20e.

In the present exemplary embodiment, the mouse 14 and the keyboard 16 are illustrated as examples of input units and will be described hereafter. However, the present invention is not limited thus and the information processing device 10 may be provided with different input units (for example, a touch pen).

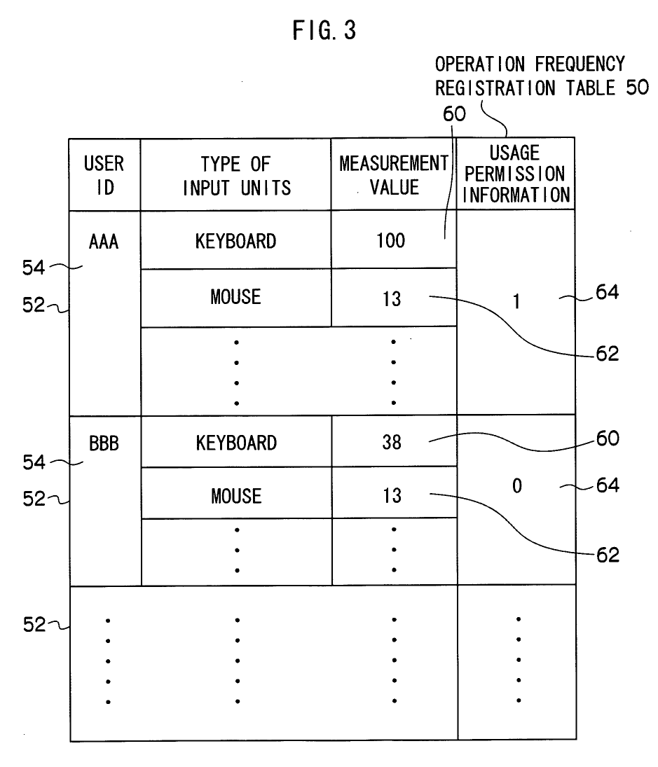

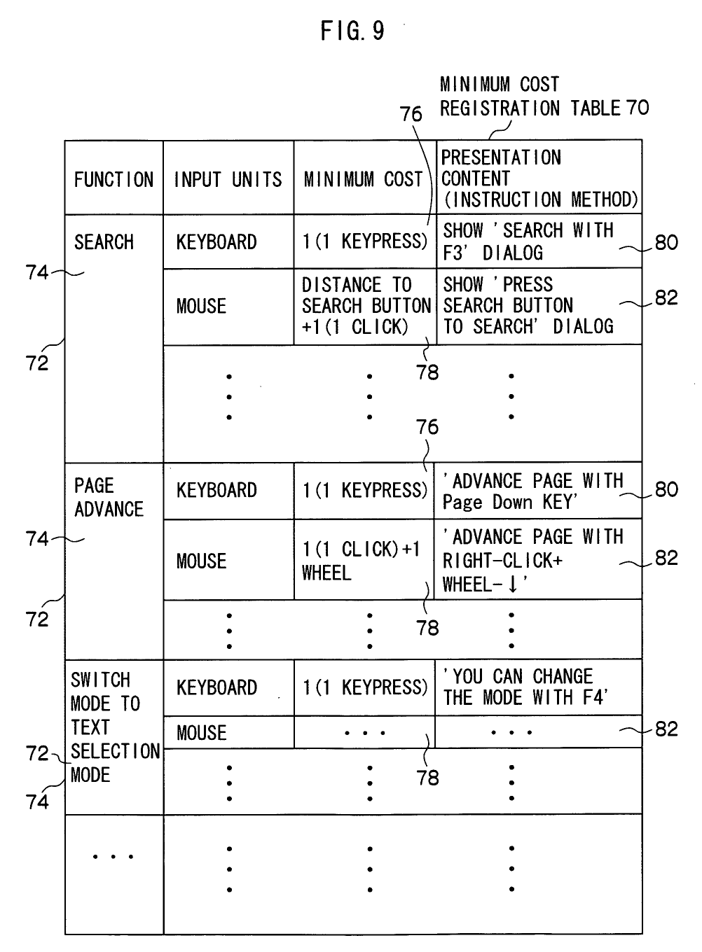

The HDD 20b memorizes an operation frequency registration table 50 (see FIG. 3), which is used in the operation frequency detection processing routine, and a minimum cost registration table 70 (see FIG. 9). The minimum cost registration table 70 memorizes, for each of the input units, an optimum work quantity (cost) for each of the plurality of input units, which is required from the start of operation up to the start of execution (or up to completion of instruction of execution) of a function, and a method up to the start of the execution or the completion of the instruction, with the optimum work quantity.

Herein, a work quantity (cost) is a value quantifying an operation of a user that is required for executing a function.

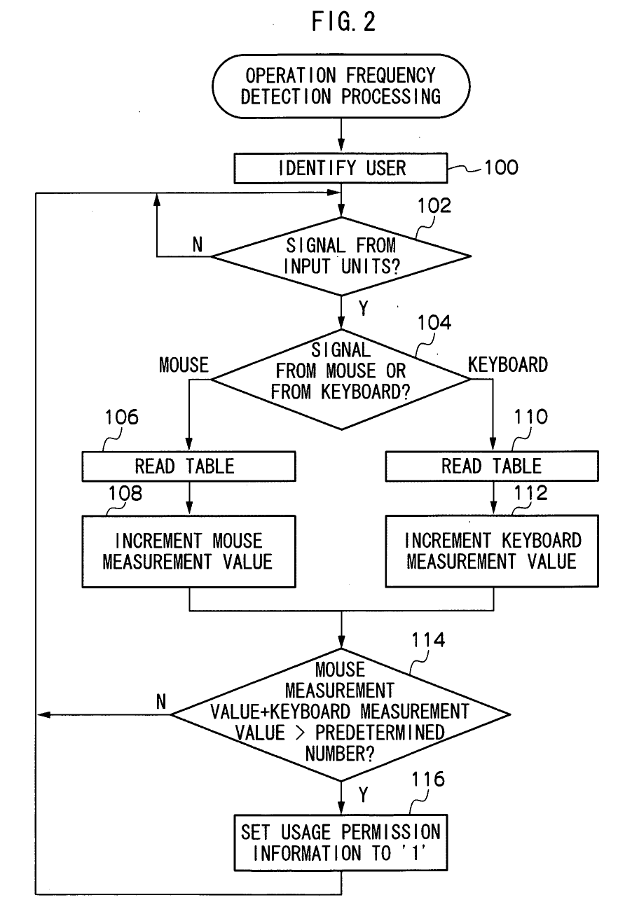

Next, operation of the control device 20 will be described. The operation frequency detection processing routine that is executed by the CPU 20c of the control device 20 will be described using FIG. 2. In the present exemplary embodiment, this operation frequency detection processing routine is executed when a switch (not shown) of the PC 12 is turned on.

First, in step 100, information is acquired, such as a user ID of a user who is logged in at the PC 12 and suchlike. Hence, when an input unit such as the mouse 14, the keyboard 16 or the like is operated, the user who is operating the input unit can be identified.

Then, in step 102, it is judged whether or not a signal representing an operation has been inputted from the mouse 14 or the keyboard 16.

If it is judged in step 102 that a signal has been inputted, it is then judged in step 104 whether the inputted signal is a signal from the mouse 14 or a signal from the keyboard 16.

If it is judged in step 104 that the inputted signal is a signal from the mouse 14, then in step 106, the operation frequency registration table 50 as shown in FIG. 3 is read from the HDD 20b, and a record 52 in which the user ID acquired in step 100 is registered in a field 54 is specified.

Now, the operation frequency registration table 50 will be described using FIG. 3.

The operation frequency registration table 50 is memorized in the HDD 20b. In the operation frequency registration table 50, the records 52 are registered for each of user IDs for which users are specified, as is shown in FIG. 3.

Each record 52 includes the field 54, which registers a user ID for specifying a user, a field 60, a field 62 and a field 64. The field 60 registers a measurement value when an operation frequency (for example, a number of occurrences of operation) of the keyboard 16 has been measured. The field 62 registers a measurement value when an operation frequency of the mouse 14 has been measured. The field 64 registers usage permission information, which represents whether a reliability of the information in the record is above a predetermined value. If a sum of the measurement values registered in the field 60 and the field 62 is at or above a predetermined value, it is judged that the reliability of the information in the record is above the predetermined value, and usage permission information ‘1’ is registered in the field 64.

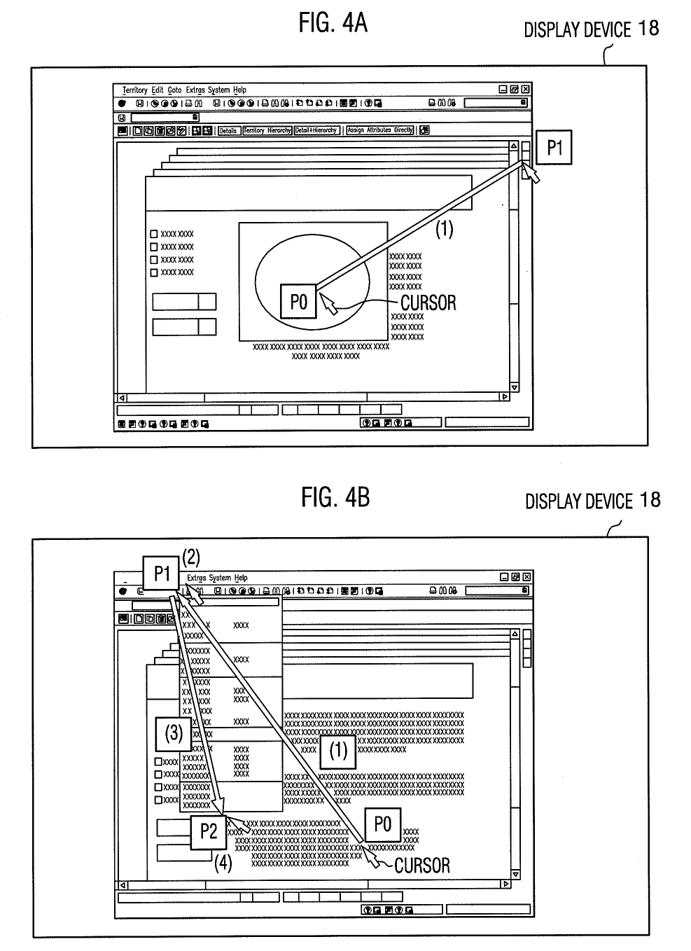

Then, in step 108, the value in the field 62 of the record 52 that was specified in step 106 is incremented. For example, when the mouse 14 is operated, in a case as shown in FIG. 4A in which the cursor displayed at the display device 18 moves from ‘P0’ to ‘P1’ and stops, it is judged that the number of operations of the mouse 14 is ‘1’ (that is, a number of operations ‘1’ of the mouse 14 is detected). Thus, in step 108, the value of the field 62 of the record 52 specified in step 106 is incremented by ‘1’. Alternatively, when the mouse 14 is operated, in a case as shown in FIG. 4B in which the cursor displayed at the display device 18 moves from ‘P0’ to ‘P1’ and stops (number of operations, ‘1’), the click-button is pressed with the cursor disposed at ‘P1’ in order to open a display menu (number of operations, ‘2’), the cursor is moved to and stops at a position (‘P2’) of a text selection mode in the display menu that has been opened by the pressing of the click-button (number of operations, ‘3’), and the click-button is pressed with the cursor disposed at ‘P2’ in order to select the text selection mode as a mode (number of operations, ‘4’), then it is judged that the number of operations of the mouse 14 is ‘4’ (that is, a number of operations ‘4’ of the mouse 14 is detected). Thus, in step 108, the value of the field 62 of the record 52 specified in step 106 is incremented by ‘4’.

Then, in step 114, it is judged whether or not a sum of the measurement value in the field 60 of the record 52 specified in step 106 and the measurement value in the field 62 is at or above a predetermined value K. This predetermined value K may be specified by experimentally or statistically finding a measurement value with which it can be reliably judged that the input unit with the highest measurement value among the plurality of input units (in the present exemplary embodiment, the mouse 14 and the keyboard 16) is an input unit that is easier to use for a user (that is, the input unit that is optimum for the user), and setting the measurement value that is found as the predetermined value K.

If it is judged in step 114 that the sum is not greater than the predetermined value K, the routine returns to step 102.

On the other hand, if it is determined in step 114 that the sum is greater than or equal to the predetermined value K, the routine advances to a next step 116.

In step 116, if the routine has advanced through step 106 to step 114 and advanced from step 114 to step 116, the usage permission information in the field 64 of the record 52 that was specified in step 106 is set to ‘1’. Then the routine returns to the aforementioned step 102.

Meanwhile, if it is judged in step 104 that the inputted signal is a signal from the keyboard 16, then in step 110, the operation frequency registration table 50 is read from the HDD 20b, and the record 52 in which the user ID acquired in step 100 is registered in the field 54 is specified.

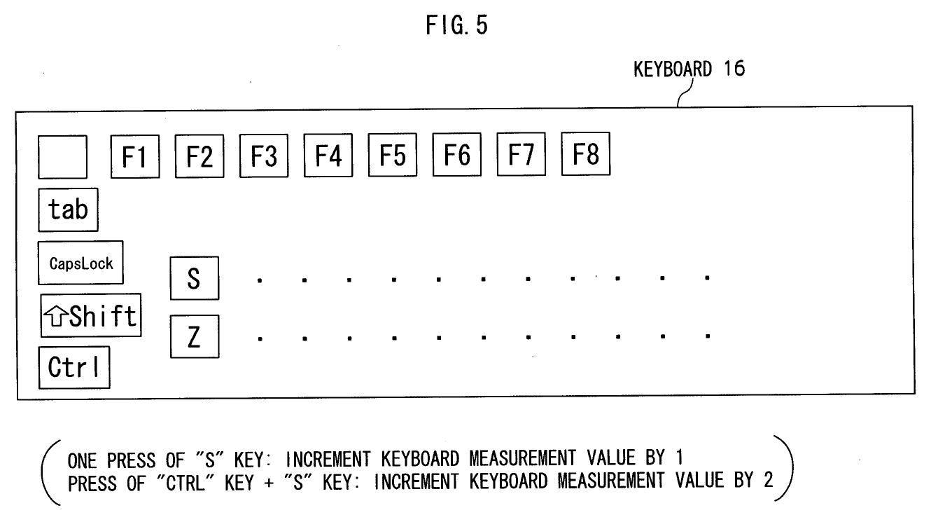

Then, in step 112, the value of the field 60 of the record 52 that was specified in step 110 is incremented. For example, in a case in which an “S” key of the keyboard 16 as shown in FIG. 5 is pressed once, it is judged that the number of operations of the keyboard 16 is ‘1’ (that is, a number of operations ‘1’ of the keyboard 16 is detected). Thus, in step 112, the value of the field 60 of the record 52 specified in step 110 is incremented by ‘1’. Alternatively, if a “Ctrl” key and the “S” key of the keyboard 16 are pressed, it is judged that the number of operations of the keyboard 16 is ‘2’ (that is, a number of operations ‘2’ of the keyboard 16 is detected). Thus, in step 112, the value of the field 60 of the record 52 specified in step 110 is incremented by ‘2’.

Then, the routine advances to the above-described step 114. If the routine advances from step 114 to step 116, the usage permission information in the field 64 of the record 52 that was specified in step 110 is set to ‘1’.

As described above, operation frequencies of the input units which are operated by the user are detected for each input unit by this operation frequency detection processing, and registered in the operation frequency registration table 50.

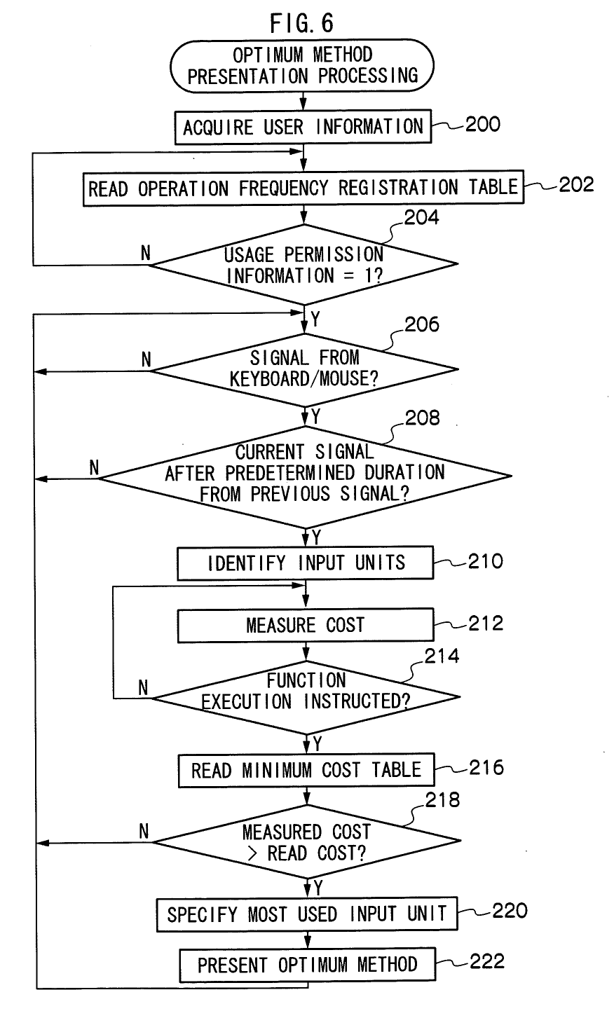

Next, the optimum method presentation processing routine executed by the CPU 20c of the control device 20 will be described using FIG. 6. In the present exemplary embodiment, this optimum method presentation processing routine is executed when a switch (not shown) of the PC 12 is turned on.

Firstly, in step 200, information is acquired, such as a user ID of a user who is logged in at the PC 12 and suchlike. Hence, when input unit, such as the mouse 14, the keyboard 16 or the like, is operated, the user who is operating the input unit can be identified.

Then, in step 202, the operation frequency registration table 50 is read from the HDD 20b, and the record 52 that includes the user ID acquired in step 200 in the field 54 thereof is specified.

Then, in step 204, it is judged whether or not the value of the usage permission information in the field 64 of the record 52 specified in step 202 is ‘1’.

In step 204, if it is judged that the value of the usage permission information is not ‘1’, then reliability of the information registered in the specified record 52 is low. Accordingly, it is judged that processing subsequent to step 204 cannot be performed using the record 52; that is, it is judged that it is not permissible to use the record 52, and the routine returns to step 202.

On the other hand, if it is judged in step 204 that the value of the usage permission information is ‘1’, then the reliability of the information registered in the specified record 52 is high. Accordingly, it is judged that processing subsequent to step 204 can be performed using the record 52; that is, it is judged that it is permissible to use the record 52, and the routine advances to a next step 206.

Then, in step 206, it is judged whether or not a signal representing an operation of the mouse 14 or the keyboard 16 has been inputted from the mouse 14 or the keyboard 16.

If it is judged in step 206 that the signal has not been inputted, the judgment of step 206 is carried out again.

Then, when it is judged in step 206 that a signal has been inputted, it is then judged in step 208 whether or not the signal representing an operation that has been inputted from the mouse 14 or keyboard 16 this time (i.e., most recently) is a signal which has been inputted later than a predetermined duration T from when a signal representing an operation was previously inputted (i.e., the time one previous to this time) from the mouse 14 or the keyboard 16. This predetermined duration T may be specified experimentally or statistically by, for example: a user operating an input unit such as the mouse 14, the keyboard 16 or the like in order to execute a predetermined function of an application; a duration from completion of this operation until the user operates an input unit such as the mouse 14, the keyboard 16 or the like again, in order to again start execution of the predetermined function of the application, being found a plurality of times; an average of durations that are found being calculated; and the calculated average duration being set as the predetermined duration T. The predetermined function may be, for example, a search function for finding a text string, a page advance function for changing a page that is displayed, a text selection mode mode-switch function for switching a mode to a text selection mode, or the like.

If it is judged in step 208 that the signal inputted this time is not a signal inputted later than the predetermined duration T since the previously inputted signal, then the routine returns to the aforementioned step 206.

On the other hand, if it is judged in step 208 that the signal inputted this time is a signal inputted later than the predetermined duration T since the previously inputted signal, then it is judged that operation of the input unit by the user for starting execution of the predetermined function has started, and the routine advances to a next step 210.

In step 210, the input unit that is being operated by the user is identified on the basis of the signal representing the operation that has been inputted this time (most recently). For example, in step 210, if the signal inputted this time is a signal from the mouse 14, the input unit being operated by the user is identified as the mouse 14, and if the signal inputted this time is a signal from the keyboard 16, the input unit being operated by the user is identified as the keyboard 16.

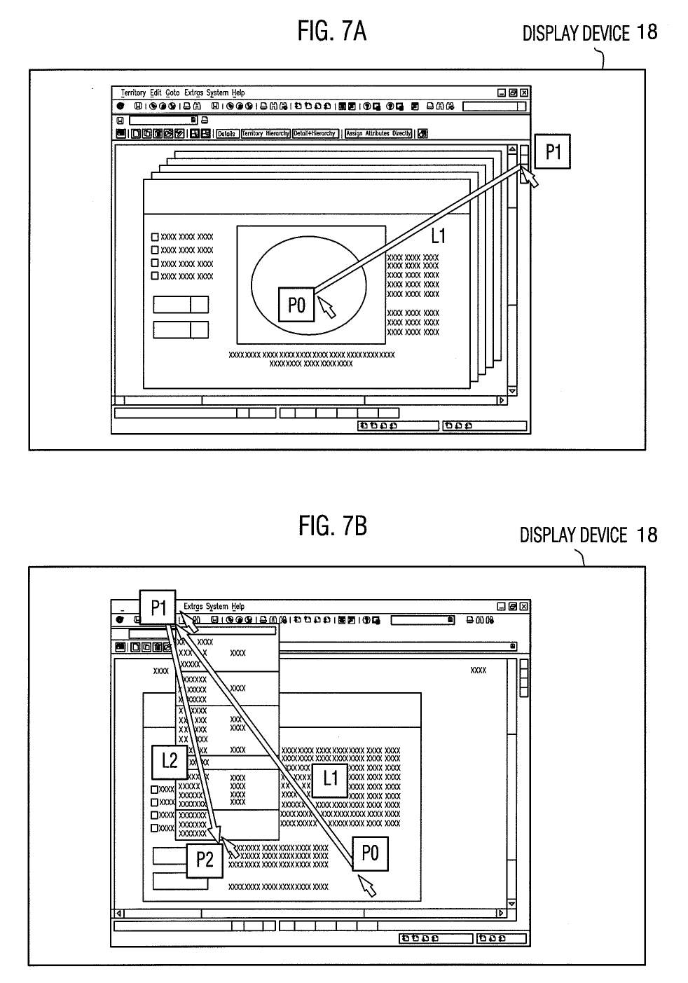

Then, in step 212, a cost (work quantity) is measured. For example, in step 212, when the mouse 14 is operated, in a case in which the cursor displayed at the display device 18 is moved from ‘P0’ to ‘P1’ and stopped as shown in FIG. 7A, a cost with the mouse 14 is measured by calculating a distance L1 of the cursor (a distance from ‘P0’ to ‘P1’) as the cost. Alternatively, in a case in which the mouse 14 is operated as shown in FIG. 7B, the cursor displayed at the display device 18 is moved from ‘P0’ to ‘P1’ and stopped, the click-button is pressed with the cursor disposed at ‘P1’ in order to open the display menu, the cursor is moved to and stopped at a position (‘P2’) of the text selection mode in the display menu opened by the pressing of the click-button, and the click-button is pressed with the cursor disposed at ‘P2’ in order to select the text selection mode as a mode. In this case, a cost with the mouse 14 is measured by calculating a distance of the cursor (i.e., L1 (the distance from ‘P0’ to ‘P1’)+L2 (the distance from ‘P1’ to ‘P2’)) as the cost.

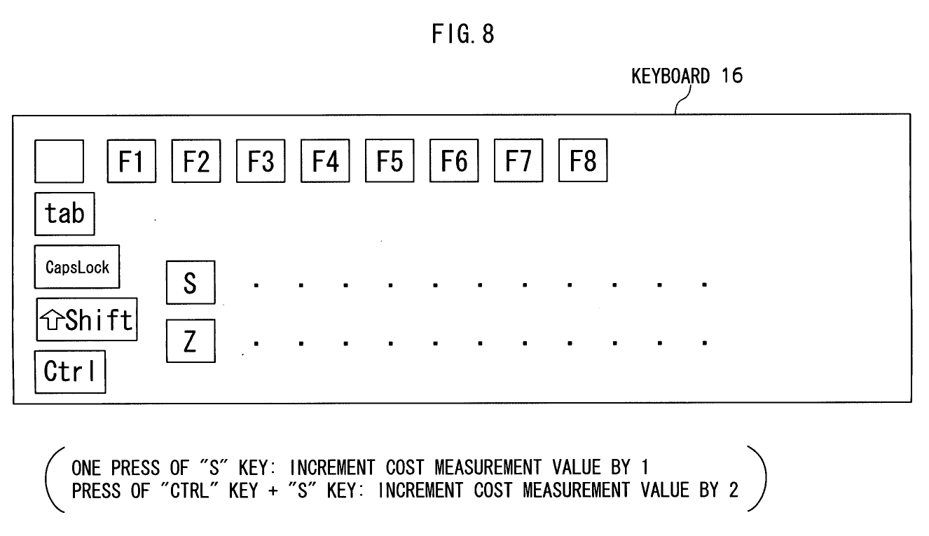

Alternatively, in a case in which, for example, the “S” key of the keyboard 16 as shown in FIG. 8 is pressed once, it is judged in step 212 that the cost is ‘1’, to measure the cost with the keyboard 16. Alternatively, in a case in which both the “Ctrl” key and the “S” key of the keyboard 16 are pressed, it is judged that the cost is ‘2’, to measure the cost with the keyboard 16.

In step 214, it is judged whether or not an instruction to execute a predetermined function of an application has been inputted. Predetermined functions here may be, for example, a search function for finding a text string, a page advance function for changing a page that is displayed, a text selection mode mode-switch function for switching a mode to a text selection mode, and the like.

If it is judged in step 214 that an instruction to execute a predetermined function has not been inputted, the routine returns to step 212, and processing to measure the cost with the respective input units continues.

On the other hand, if it is judged in step 214 that an instruction to execute a predetermined function has been inputted, the routine advances to a next step 216.

Thus, a cost required from start of the operation of the input unit identified in step 210 up to starting execution (or completing instruction of execution) of the function is measured by step 212 and step 214.

Then, in step 216, the minimum cost registration table 70 memorized in the HDD 20b is read from the HDD 20b, and information corresponding to the instruction to execute a predetermined function that has been inputted is acquired.

Now, the minimum cost registration table 70 will be described using FIG. 9.

The minimum cost registration table 70 will have been memorized in the HDD 20b. In the minimum cost registration table 70, a record 72 may be registered for each function that can be executed by the user operating the input units.

The record 72 includes a field 74, a field 76, a field 78, a field 80 and a field 82. The field 74 registers a function that is executed by a user operating the input units. The field 76 registers a minimum cost, which is a cost required from starting operation up to starting execution (completing instruction of the execution) in a case the function registered in the field 74 of the record 72 is executed by operation of the keyboard 16. The field 78 registers a minimum cost, which is a cost required from starting operation up to starting execution (completing instruction of the execution) in a case the function registered in the field 74 of the record 72 is executed by operation of the mouse 14. The field 80 registers a method for instructing execution of the function registered in the field 74 by operation of the keyboard 16, with the minimum cost registered in the field 76 of the record 72. The field 82 registers an instruction method for instructing execution of the function registered in the field 74 by operation of the mouse 14, with the minimum cost registered in the field 78 of the record 72. Herein, the minimum cost registered in the field 76 is considered to be an optimum cost for users, being a cost with which execution of the corresponding function can be instructed easily using the keyboard 16. The minimum cost registered in the field 78 is also considered to be an optimum cost for users, being a cost with which execution of the corresponding function can be instructed easily using the mouse 14.

In step 216, the minimum cost registration table 70 is read from, for example, the HDD 20b and, in accordance with the inputted instruction to execute the function, the record 72 in which the function to be executed by this instruction is registered in the field 74 thereof is acquired.

Then, in step 218, if it was judged in step 210 that the input units being operated by the user is the keyboard 16, then the optimum cost registered in the field 76 of the record 72 acquired in step 216 is compared with the cost required from start of operation up to starting execution (or completing instruction of execution) of the function that has been measured by step 212 and step 214. If the cost measured by step 212 and step 214 is larger (that is, if the cost measured by step 212 and step 214 differs from the minimum cost registered in the field 76 of the record 72 acquired in step 216), then the routine advances to a next step 220. On the other hand, if the minimum cost registered in the field 76 of the record 72 acquired in step 216 is the same as the cost measured by step 212 and step 214, then the processing routine returns to the step 206.

Alternatively, in step 218, if it was judged in step 210 that the input units being operated by the user is the mouse 14, then the optimum cost registered in the field 78 of the record 72 acquired in step 216 is compared with the cost required from start of operation up to starting execution (or completing instruction of execution) of the function that has been measured by step 212 and step 214. If the cost measured by step 212 and step 214 is larger (that is, if the cost measured by step 212 and step 214 differs from the minimum cost registered in the field 78 of the record 72 acquired in step 216), then the routine advances to the next step 220. On the other hand, if the minimum cost registered in the field 78 of the record 72 acquired in step 216 is the same as the cost measured by step 212 and step 214, then the processing routine returns to the step 206.

In step 220, the input units that has a higher operation frequency for the user who was identified in step 200 is specified on the basis of the record 52 that was specified in step 202. For example, in step 220, the measurement value registered in the field 60 of the record 52 specified in step 202 is compared with the measurement value registered in the field 62 of the record 52 specified in step 202. If the measurement value registered in the field 60 is larger than the measurement value registered in the field 62, it is judged that the operation frequency of the keyboard 16 is higher, and the keyboard 16 is specified as the input unit with the higher frequency of operation by the user. Alternatively, in step 220, if, for example, the measurement value registered in the field 60 of the record 52 specified in step 202 is compared with the measurement value registered in the field 62 of the record 52 specified in step 202 and the measurement value registered in the field 62 is larger than the measurement value registered in the field 60, then it is judged that the operation frequency of the mouse 14 is higher, and the mouse 14 is specified as the input unit with the higher frequency of operation by the user.

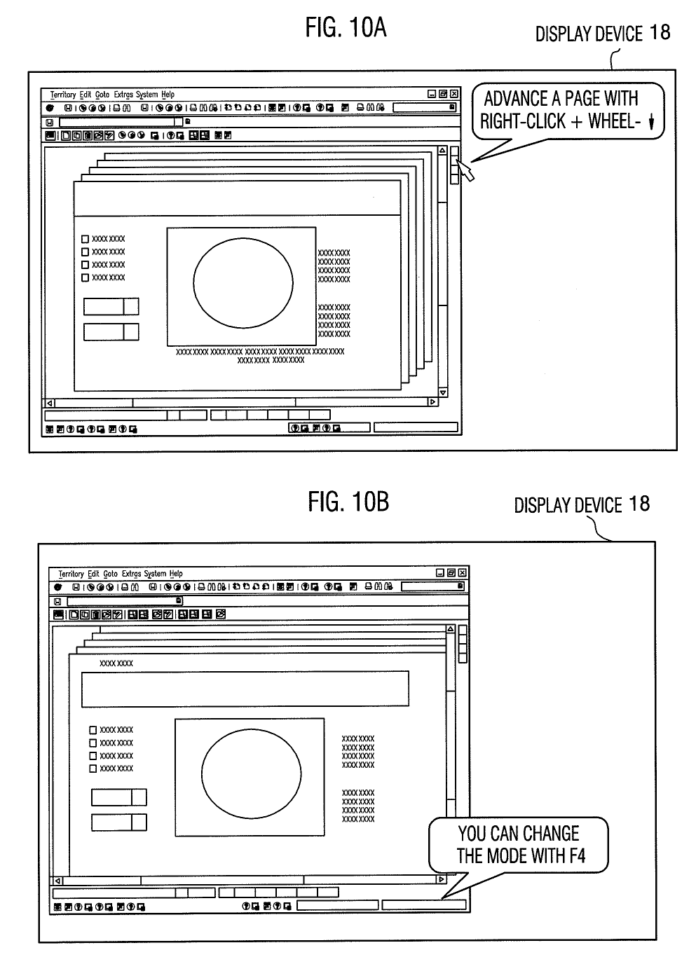

Then, in step 222, it is specified whether a field of the record 72 acquired in step 216 in which an instruction method that corresponds to the input unit specified in step 220 is registered is the field 80 or the field 82, and the display device 18 is controlled so as to display the method registered in the specified field. Thus, for example, “You can advance a page with right-click+mouse-wheel ↓” as shown in FIG. 10A is displayed, or “You can change the mode with F4” as shown in FIG. 10B is displayed. Thus, a method to instruct the executed function with a work quantity that is optimum for that user is presented.

Anyway, for the present exemplary embodiment, an example has been described in which the input unit with the highest operation frequency by the user is specified in step 220 of the optimum method presentation processing routine, and the instruction method that corresponds to the input units with the highest operation frequency is displayed in step 222. However, the present invention is not limited thus. It is also possible to control the display device 18 in step 222 so as to display an instruction method that corresponds to the input unit that is being operated by the user as identified in step 210.

Moreover, for the present exemplary embodiment, an example has been described in which, in step 212 of the optimum method presentation processing routine, if a key of the keyboard 16 is pressed once when a cost with the keyboard 16 is being measured, whatever key is pressed, the cost is measured as ‘1’. However, the present invention is not limited thus. For example, it can be thought that ease for a user when pressing a key is lower when pressing the “Z” key, which has a high likelihood of being pressed with the little finger, than when pressing the “F” key, which has a high likelihood of being pressed with the index finger. Thus, a cost when pressing the “Z” key may be defined so as to be larger than a cost when pressing the “F” key. In such a case, predetermined weightings in accordance with positions of the keys of the keyboard 16 or suchlike may be applied, and the cost of each key appropriately defined so as to measure appropriate costs of the respective keys.

Furthermore, in the present exemplary embodiment, the minimum cost registration table 70 is pre-memorized in the HDD 20b. It is also possible, for example, in a case in which the totality of functions includes functions with a frequency of use above a predetermined value, to assign shortcut keys to those functions and register the assigned shortcut keys in the minimum cost registration table 70 with the corresponding functions.

Further yet, for the present exemplary embodiment, an example has been described in which a cost with the mouse 14 is a distance of movement of the cursor. However, the present invention is not limited thus. Costs with the mouse 14 may be one or more of distances of movement of the cursor and numbers of clicks of the mouse.

What is claimed is:

1. An information processing device comprising:
a plurality of input units;
a memory that stores information which includes, in correspondence with each other,
an input unit to be operated to instruct execution of a function of the information processing device,
a first cost required to instruct the execution of the function using the input unit, and
an instruction method to instruct the execution, with the first cost and using the input unit;
an identification unit that identifies which of the plurality of input units is being operated to instruct the execution of the function by a user;
a measurement unit that measures a second cost required from start of the user's operation of the identified input unit up to instruction of the execution of the function; and
a presentation unit that, if the measured second cost differs from the first cost stored in the memory in correspondence with the identified input unit, presents to the user information on the instruction method stored in the memory in correspondence with the identified input unit.

2. An information processing device comprising:
a plurality of input units;
a memory that stores information which includes, in correspondence with each other,
an input unit to be operated to instruct execution of a function of the information processing device,
a first cost required to instruct the execution of the function using the input unit, and
an instruction method to instruct the execution, with the first cost and using the input unit;
an identification unit that identifies which of the plurality of input units is being operated to instruct the execution of the function by a user;
a user identification unit that identifies the user who is operating the input unit;
a detection unit that detects an operation frequency at which the input unit is operated by the identified user;
a specification unit that, on the basis of the detected operation frequency, specifies for which of the input units the operation frequency is higher for the identified user;
a measurement unit that measures a second cost required from start of the user's operation of the identified input unit up to instruction of the execution of the function; and
a presentation unit that, if the measured second cost differs from the first cost stored in the memory in correspondence with the identified input unit, presents to the user information on the instruction method that is stored in the memory in correspondence with the input unit specified by the specification unit.

3. The information processing device of claim 1, wherein the plurality of input units includes a mouse that moves a displayed cursor and clicks a button at which the cursor is displayed,
and the first cost and the second cost include at least one of a distance of movement of the cursor and a number of occurrences of clicking.

4. The information processing device of claim 1, wherein the plurality of input units includes a keyboard equipped with a plurality of buttons that input information,
and the first cost and the second cost include a number of presses of the buttons.

5. The information processing device of claim 1, wherein the information stored in the memory is stored for each of a plurality of functions of the information processing device.

6. The information processing device of claim 2, wherein the plurality of input units includes a mouse that moves a displayed cursor and clicks a button at which the cursor is displayed,
and the first cost and the second cost include at least one of a distance of movement of the cursor and a number of occurrences of clicking.

7. The information processing device of claim 2, wherein the plurality of input units includes a keyboard equipped with a plurality of buttons that input information,
and the first cost and the second cost include a number of presses of the buttons.

8. The information processing device of claim 2, wherein the information stored in the memory is stored for each of a plurality of functions of the information processing device.

9. A computer-readable medium storing a program causing a computer to execute a process for presenting a method, the process comprising:
storing information which includes, in correspondence with each other,
an input unit to be operated to instruct execution of a function of the computer,
a first cost required to instruct the execution of the function using the input unit, and
an instruction method to instruct the execution, with the first cost and using the input unit;
identifying, from a plurality of input units to be operated for instructing the execution of the function, which of the input units is being operated by a user;
measuring a second cost required from start of the user's operation of the identified input unit up to instruction of the execution of the function; and
if the measured second cost differs from the stored first cost in correspondence with the identified input unit, presenting to the user information on the instruction method stored in correspondence with the identified input unit.

10. A computer-readable medium storing a program causing a computer to execute a process for presenting a method, the process comprising:
storing information which includes, in correspondence with each other,
an input unit to be operated to instruct execution of a function of the computer,
a first cost required to instruct the execution of the function using the input unit, and
an instruction method to instruct the execution, with the first cost and using the input unit;
identifying, from a plurality of input units to be operated for instructing the execution of the function, which of the input units is being operated by a user;
identifying the user who is operating the input unit;
detecting an operation frequency at which the input unit is operated by the identified user;
on the basis of the detected operation frequency, specifying for which of the input units the operation frequency is higher for the identified user;
measuring a second cost required from start of the user's operation of the identified input unit up to instruction of the execution of the function; and
if the measured second cost differs from the stored first cost in correspondence with the identified input unit, presenting to the user information on the instruction method stored in correspondence with the specified input unit.

11. An information processing method comprising:
storing information which includes, in correspondence with each other,
an input unit to be operated to instruct execution of a function of the computer,
a first cost required to instruct the execution of the function using the input unit, and
an instruction method to instruct the execution, with the first cost and using the input unit;
identifying, from a plurality of input units to be operated for instructing the execution of the function, which of the input units is being operated by a user;
measuring a second cost required from start of the user's operation of the identified input unit up to instruction of the execution of the function; and
if the measured second cost differs from the stored first cost in correspondence with the identified input unit, presenting to the user information on the instruction method stored in correspondence with the identified input unit.
